(19) United States
(12) Patent Application Publication
(10) Pub. No.: US 2025/0277506 A1
(43) Pub. Date: Sep. 4, 2025

(54) Axial and Radial Sliding Bearing

(71) Applicant: Igus GmbH, Köln (DE)

(72) Inventor: David Szepokat, Köln (DE)

(21) Appl. No.: 18/859,031

(22) PCT Filed: Apr. 20, 2023
(86) PCT No.: PCT/EP2023/060347

§ 371 Date: Oct. 22, 2024

(30) Foreign Application Priority Data
Apr. 22, 2022 (DE) 20 2022 102 163.5

(51) Int. Cl. F16C 17/10

(52) U.S. Cl. CPC F16C 17/10

(57) ABSTRACT

An axial and radial sliding bearing 1 that includes a first bearing element in the form of a first bearing ring 2 and a second bearing element 4, 5, 6. The bearing elements are arranged rotatably to one another about a bearing axis A. The second bearing element 4, 5, 6 forms a substantially U-shaped cross-section in order to at least partially accommodate the first bearing ring 2, as well as sliding elements 7, 8 made of a polymer material that are arranged between the first and the second bearing element in order to axially and radially decouple the bearing elements. The second bearing element 4, 5, 6 includes two bearing disc portions 4, 6 spaced from one another and at least one bearing cylinder portion 5 arranged between the two bearing disc portions and coaxially oriented to the first bearing ring 2, where the sliding elements 7, 8 have at least one axial sliding ring 7 to be arranged between radial surfaces associated with one another 50, 21 of the two bearing elements and two radial sliding rings 8 to be arranged between axial surfaces associated with one another 60, 20a, 40, 20b of the two bearing elements.

This invention relates to an axial and radial sliding bearing that comprises a first bearing element in the form of a first bearing ring and a second bearing element, wherein the bearing elements are arranged rotatably to one another about a bearing axis, and the second bearing element forms a substantially U-shaped cross-section in order to at least partially accommodate the first bearing ring, as well as sliding elements made of a polymer material that are arranged between the first and the second bearing element in order to axially and radially decouple the bearing elements.

Such axial and radial sliding bearings are designed to absorb axial as well as radial forces and are used, for example, for rotary indexing tables, dividing heads, for the design of CNC rotary axes etc. A polymer suitable for tribological loads that generally can be used without lubricants can be employed as a polymer material for manufacturing the sliding elements. A generic axial and radial sliding bearing is, for example, described in the utility model specification DE 20 2013 101 374 U1. The advantages of such conventional sliding bearings are, in particular, in the low friction of the bearing elements the one with the other, a maintenance-free operation, a low-cost production as well as a sturdy construction and a high wear-resistance. These numerous advantages have the effect that the spread of these bearings, in particular as axial and radial sliding bearings configured as polymer slewing bearings (PAT), increased steadily in the most various fields.

A slewing bearing which is completely made out of metal turning parts is known from DE 20 2004 006 697 U1.

However, there are efforts to still increase the fields of application of such axial and radial sliding bearings, in particular to such applications for which a comparatively small or light component is arranged pivotable to a fixed support section, for example in a vehicle, so that the described conventional axial and radial sliding bearings, as used in the field of CNC machines, are oversized and their production and mounting are thus costly.

Insofar, the aim of this invention is to provide the axial and radial sliding bearings known per se for applications as well for which the components to be pivoted to one another are comparatively light and small compared to conventional axial and radial sliding bearings.

This aim is achieved by the invention with an axial and radial sliding bearing with the characteristics of claim 1. The axial and radial sliding bearing according to the invention has a first bearing element in the form of a first bearing ring and a second bearing element, wherein the bearing elements are arranged rotatably to one another about a bearing axis, and the second bearing element forms a substantially U-shaped cross-section in order to at least partially accommodate the first bearing ring, as well as sliding elements made of a polymer material that are arranged between the first and the second bearing element in order to axially and radially decouple the bearing elements. The axial and radial sliding bearing according to the invention is characterized in that the second bearing element comprises two bearing disc portions spaced from one another, in particular bearing circular discs and at least one bearing cylinder portion arranged between the two bearing disc portions and coaxially oriented to the first bearing ring, wherein the sliding elements have at least one axial sliding ring to be arranged between radial surfaces associated with one another of the two bearing elements and two radial sliding rings to be arranged between axial surfaces associated with one another of the two bearing elements.

The axial and radial sliding bearing according to the invention is based on the fundamental idea to open up further fields of application of an axial and radial sliding bearing that uses sliding elements made of polymer and to simplify the design and thus the assembly of such bearings by miniaturization. This being, it became apparent that the sliding elements used for conventional axial and radial sliding bearings with a respectively substantially L-shaped cross-section that are arranged in a row relative to each other on a circumference, wherein two such rows are arranged in an axial succession between the two bearing elements, can be replaced by at least one axial sliding ring to be arranged between radial surfaces associated to one another of the two bearing elements and two radial sliding rings to be arranged respectively between associated axial surfaces of the two bearing elements without reducing the reliability of the bearing or the service life thereof. Since tilting moment loads of the respective bearing location can also be safely absorbed besides to radial and axial loads, with the axial and radial sliding bearing according to the invention despite its small size, the cost of manufacturing of the bearing, the required installation space as well as the cost for the design of connecting structures and the mounting of the bearings are significantly reduced compared to conventional axial and radial sliding bearings.

In such embodiments for which the second bearing element comprises two bearing disc portions spaced from one another and at least one bearing cylinder portion arranged between the two bearing disc portions and coaxially oriented to the first bearing ring, the second bearing element is insofar designed as a second bearing ring that completely accommodates the first bearing ring in axial direction and partially in radial direction.

The designation of surfaces of the sliding bearing according to the invention or of the components thereof as axial surfaces means surfaces that are situated substantially perpendicularly to the axial direction of the bearing or to the axis of rotation of the bearing. Correspondingly, a radial surface of the bearing or of one of its components is substantially situated perpendicularly to the radial direction of the bearing. In this way, the outer surface of a cylinder is to be designated as a radial surface on which a radius vector stands upright.

The term “axial sliding ring” means a sliding ring that has its longest extension in cylinder coordinates in the axial direction, which means that its greatest sliding surfaces is a radial surface, in particular a cylinder surface, on which a radius vector stands upright. Similarly, the term “radial sliding ring” means a sliding ring that has its longest extension in cylinder coordinates in the radial direction, which means that its greatest sliding surfaces is an axial surface that extends perpendicularly to the axis of the bearing.

Further characteristics according to the invention and further developments of the invention are indicated in the following general description, in the figures, the description of the figures as well as in the subclaims.

For the complete covering of adjacent surfaces of the first bearing element and of the second bearing element by the sliding elements, it can be provided that the axial height of the bearing cylinder portion of the second bearing element is substantially equal to the sum of the axial heights of both radial sliding rings and of the axial height of the first bearing ring and moreover is substantially equal to the axial height of the axial sliding ring. This being, it can be provided that both radial sliding rings are situated in a mounting position with their respective radially inwards lying radial surface respectively adjacent to an associated portion of the radially outwards lying radial surface of the axial sliding ring.

For simplifying the mounting of the sliding bearing according to the invention and for reducing the cost of manufacturing of the single components of the bearing according to the invention, it is provided that the axial sliding ring is constructed in one piece and has a sleeved shape that can be circumferentially closed. Further it is provided that the radial sliding rings are configured as respective ring discs so that the sliding functionality between the first bearing element and the second bearing element is provided by three sliding elements, each of them in one piece, wherein it can be furthermore provided that both ring discs have an identical structure.

Depending on the embodiment, the two axially spaced bearing disc portions of the second bearing element can have a surface area that is non circular, in particular that is angular or oval. It can also be provided that the two bearing disc portions of the second bearing element are configured as circular disc portions or circular discs, wherein the bearing cylinder portion arranged between them can, depending on the embodiment, be configured for example as a cylinder sleeve or as a full cylinder. In the latter embodiment, there results a particularly high stability of the axial and radial sliding bearing according to the invention for absorbing and transferring operating forces from the movable bearing part, that is generally the first bearing element, to the stationary bearing part that is generally provided by the second bearing element of the axial and radial sliding bearing configured according to the invention.

It can be provided that the two axially spaced bearing disc portions and the bearing cylinder portion arranged between them are made in one piece each and are connected to one another, in particular are screwed, for configuring the second bearing element. For simplifying the structure of the second bearing element, it can also be provided that the bearing cylinder portion is configured in one piece with one of the two bearing disc portions or bearing discs, wherein the other of the two bearing disc portions is fixed in mounting position to the bearing cylinder portion, for example by means of a screw connection that can be configured in particular axially to the first bearing ring or coaxially to the first bearing element.

As already described, the bearing cylinder portion can be configured as a cylinder sleeve, however in another embodiment it can also be configured as a full cylinder that can possibly comprise one or several ducts, for example for carrying out one or several screw connections.

In an embodiment in which one of the two bearing disc portions is manufactured in one piece with the bearing cylinder portion that is configured as a full cylinder, it can suitably be provided, for the design of the second bearing element, to fix the second bearing disc portion by means of a screw connection to the first mentioned part of the second bearing element, in particular by a coaxially extending screw connection, for example wherein a screw bolt extends through the first bearing disc portion and the bearing cylinder portion molded or fixed thereon or the full cylinder into the second bearing disc portion that has a screw connection bore that is in particular oriented coaxially to the first bearing ring into which the screw bolt is screwed.

For fixing the second bearing element, for example to a stationary component in the interior of a vehicle, it can suitably be provided that a multitude of ducts are configured, in particular arranged on a circumference and spaced radially to the axis of the first bearing ring, extending parallel to the axis of the bearing, that extend through the two bearing disc portions and the at least one bearing cylinder portion arranged between the two bearing disc portions and oriented coaxially therewith for accommodating each a fastening bolt.

The axial and radial sliding bearing according to the invention is suitable for configuring a bearing with comparatively small dimensions as can be used, for example, in vehicles for the pivotable fixing of a part to an interior component of the vehicle. In particular, the radial dimension of the bearing can be <80 mm, in particular ≤60 mm, and preferably ≤40 mm, which makes possible a multitude of further fields of application for the bearing. Similarly, because of the structure of the bearing according to the invention described above, it can be configured with an axial dimension <20 mm, in particular ≤16 mm, and preferably ≤12 mm.

Basically, it can be provided that the axial and radial sliding bearing according to the invention is configured in such a manner that the two bearing elements are arranged rotatable freely to one another about the axis of rotation, in particular over an angular range that is larger than a full circle. However, on the other hand, applications of the axial and radial sliding bearing according to the invention for which the two components that can be coupled pivotably to one other by the bearing are restricted in their relative movement to one another are also possible. For example, in an application, it can be necessary to realize a relative pivoting by means of the bearing over an angular range of, for example, 90° or 180°. In a multitude of applications, this limitation can be realized by providing external abutments that can be arranged, for example, on the component coupled to the bearing. In a particularly suitable embodiment, it can however also be provided that the bearing according to the invention itself has a restricting means for restricting the relative movement of the two bearing elements to one another. For example, an abutment can be provided on one of the two bearing elements that cooperates with two abutments arranged on the other bearing element for restricting the relative rotation of the two bearing elements to one another about the axis of rotation of the axial and radial sliding bearing.

In a suitable embodiment, it can be provided that the restricting means comprises an arm portion arranged on one of the two bearing elements and extending axially therefrom, that engages axially into an elongated hole arranged on the circumference on the other of the two bearing elements for restricting the relative pivoting of the two bearing elements to one another over a predetermined angle range. For this embodiment, the two front ends of the elongated hole form insofar abutments for the arm portion extending into the elongated hole that cooperates with these two abutments for restricting the pivoting. In this embodiment, the circumferential extension of the elongated hole clearly defines the predetermined angle range.

In certain embodiments, it can be suitable to facilitate the adjustment of one or of several operating positions of the two bearing elements to one another. To this purpose, the set-up of one or of several latching positions between the two bearing elements can be suitably provided. In particular, it can be provided that at least one of the two bearing elements has a seat for a latching element accommodated therein, in particular a spring-loaded deflectable latching element, and the other of the two bearing elements comprises a latching recess associated to the latching element for accommodating at least partially the deflectable latching element for providing a releasable latch for a predetermined relative rotary position of the two bearing elements to one another. This being, it can be provided that the other of the two bearing elements has a multitude of circumferentially spaced latching recesses for the successive accommodating of the latching element during a rotation of the two bearing elements to one another for providing a multitude of latching positions that differ with respect to the relative rotary positions of the two bearing elements to one another.

According to the invention, the arrangements latching element and latching recess configured complementarily and to cooperate can be arranged on facing boundary surfaces of the two bearing elements. In a suitable embodiment, it can be provided that the latching element and the at least one latching recess are arranged on respectively facing radial surfaces of the one or of the other bearing element. This being, it can be provided that the latching element arranged in the seat of the one bearing element is subjected to a force in the radial direction and is arranged deflectable for providing a latching of the two bearing elements to one another in the radial direction when adjusting a predetermined relative rotational position of the two bearing elements. However, it can also be provided that the latching element and the at least one latching recess are arranged on respectively facing axial surfaces of the one and of the other bearing element and that the latching element arranged in the seat of the one bearing element is subject to a force in the axial direction and is deflectable.

The design of the bearing according to the invention that provides the functionality of the latching of the two bearing elements to one another can be carried out in such a manner that the release torque for releasing the latching of the two bearing elements to one another can be produced by applying a predetermined torque to one of the bearing elements, while the other bearing element is held stationary, wherein this predetermined torque constitutes a torque threshold beyond which the latching can be released. To this end, the latching element and/or the latching recess can be configured with corresponding curved latching surfaces. It can suitably be provided, for example, that the latching element has at least partially a spherical or cylindrical latching surface that corresponds, in a latching position or detent position of the latching element, to the at least one associated latching recess with a complementarily configured latching surface of this latching recess. The term latching surface means insofar contact surface of the bearing element or of the associated latching recess. Due to the described curved design of the latching surfaces or contact surfaces, the desired releasability of the latching can be provided in a simple way. Due to a corresponding design of the latching surfaces of the latching element and of the latching surfaces of the latching recess associated to the latching element, it can be provided that the release torque is adjusted differently depending on the direction of rotation of the two bearing elements to one another, which can be suitable for certain applications.

The axial and radial sliding bearing designed according to the invention is suitable in particular for being used in the interior of vehicles, in particular of aircraft, land vehicles or watercraft. For example, the axial and radial sliding bearing according to the invention can be used for the pivotable mounting of a retaining or display element on a component of the interior, wherein the element to be pivoted is fixed to one of the two bearing elements of the bearing and the component of the interior to the other bearing element of the axial and radial sliding bearing designed according to the invention.

The invention shall be explained below by describing an embodiment and modifications with reference to the accompanying figures.

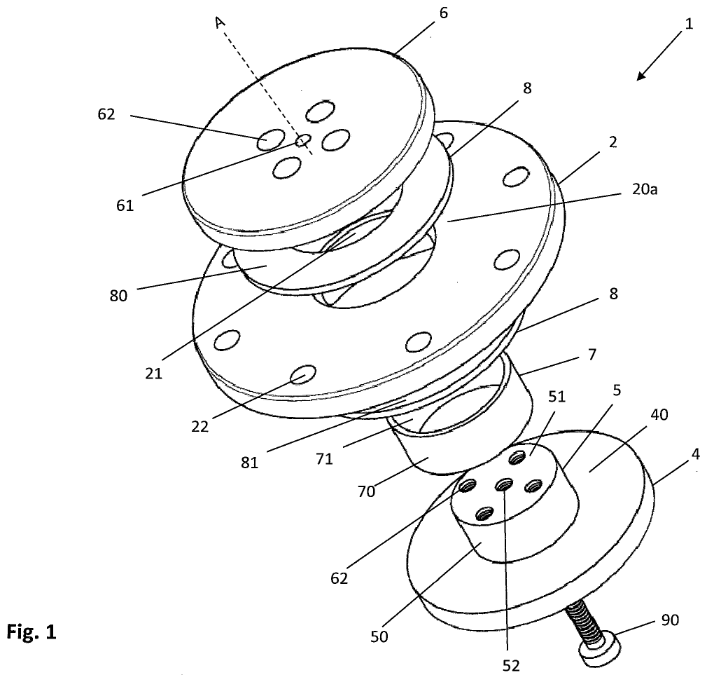

FIG. 1 shows a perspective exploded view of an axial and radial sliding bearing designed according to the invention.

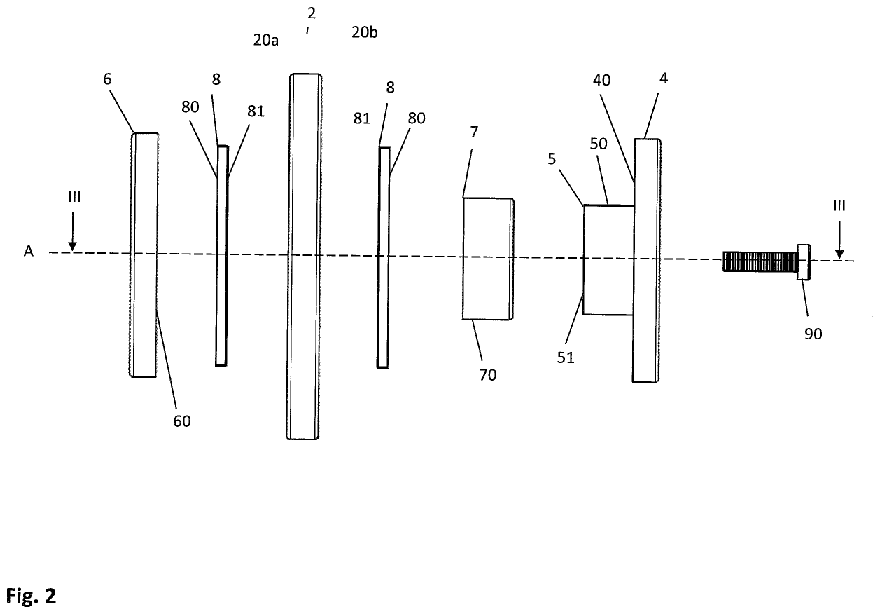

FIG. 2 shows a lateral exploded view of FIG. 1.

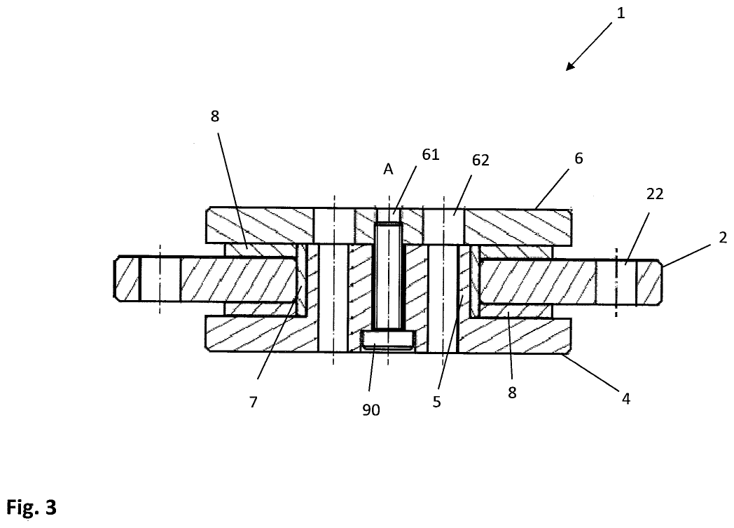

FIG. 3 shows a section through the assembled bearing in the section plane III-III indicated in FIG. 2.

In FIG. 1, an axial and radial sliding bearing according to the invention is shown in a perspective exploded view as it is designed, for example, for the use in interiors of vehicles, in particular of aircraft, land vehicles, or watercraft, in order, for example, to realize a pivotable mounting of a retaining or table element to a component of the interior of the vehicle.

The bearing 1 has a first bearing element in the form of a first bearing ring 2 that is arranged coaxially to a second bearing element and that is accommodated by this element over its overall axial extension and over a portion of its radial extension. In the described embodiment, the second bearing element comprises two circular discs 4, 6, coaxially oriented to the first bearing ring 2, that are axially spaced by an again coaxially oriented cylinder shoulder 5. This being, the illustrated lower circular disc 4 and the cylinder shoulder 5 are designed integral and in a single piece, wherein the circular disc 6 arranged spaced from the circular disc 4 is attached with screws to the component 4, 5 manufactured in a single piece. In the represented embodiment, the circular disc 4 manufactured in a single piece with the cylinder shoulder 5 has a central bore 52 through which an insofar coaxially running fastening bolt 90 extends in assembled condition, wherein this bolt can be screwed into an associated coaxial threaded bore 61 of the circular disc 6 for configuring the described second bearing element that comprises the portions 4, 5 and 6.

In a section that comprises the longitudinal axis A of the sliding bearing 1, the second bearing element (4, 5, 6) is insofar configured approximately U-shaped. Both bearing elements 2 (4, 5, 6) can be produced of the same or a different metallic material such as aluminum or steel. However, it is also possible to produce at least one of the bearing elements or both elements of a plastic material, in particular partially.

In an embodiment that is not represented, it can also be provided that the second bearing element (4, 5, 6) can be designed by joining, in particular by screwing, three single components, namely the two circular discs 4, 6 and the cylinder shoulder 5 manufactured separately from the circular discs. In this embodiment, as in the embodiment in which the second bearing element comprises two single components, a single screw bolt 90, extending coaxially to the axis A of the bearing, can be used, wherein it extends axially throughout the circular discs 4, 6 and the cylinder shoulder 5, as indicated above, and is thus screwed into the threaded bore 61 of the in FIG. 1 upper circular disc of the bearing.

When the axial and radial sliding bearing designed according to the invention of FIG. 1 is assembled, both bearing elements, i.e., the first bearing ring 2 and the second bearing element provided by the portions or components 4, 5, 6, are rotatably arranged relatively to one another about an axis of rotation A. In order to minimize the friction between the components or surfaces movable to one another, the sliding bearing 1 comprises in the described embodiment three single sliding elements that are arranged between the first and second bearing elements in order to axially and radially decouple the bearing elements. A first sliding element is configured as a cylindrical sliding sleeve 7 with a cylindrical inner circumferential surface 71 and a cylindrical outer circumferential surface 70. The inner diameter of the sliding sleeve 7 is adapted to the diameter of the cylinder shoulder 5 in such a manner that, when the bearing is assembled, the cylinder inner circumferential surface 71 of the sliding sleeve 7, that acts as a radial surface, bears on the cylinder circumferential surface 50 of the cylinder shoulder 5 that again constitutes a radial surface. Similarly, the outer diameter of the sliding sleeve 7 is adapted to the inner diameter of the bore of the first bearing ring 2 in such a manner that, when the bearing configured according to the invention is assembled, the cylinder outer circumferential surface 70 of the sliding sleeve 7, that is insofar configured as a radial surface, bears on the radially inner cylinder surface 21 of the first bearing ring 2 that defines the inner bore of the first bearing ring 2.

For decoupling associated axial surfaces of the first bearing ring 2 and of the two circular discs 4, 6, two sliding rings 8 spaced by the axial thickness of the circular disc 2 are provided that are designated here as radial sliding rings since the radial extension of their sliding surfaces is greater than the axial extension of their sliding surfaces.

The mutual contact of the associated axial surfaces of the bearing elements as well as of the sliding rings 8 shall now be explained below with reference to FIG. 2 that shows a lateral exploded view of the axial and radial sliding bearing according to the invention of FIG. 1 with indication of the relevant axial surfaces, i.e., of the surfaces that extend perpendicularly to the axial direction and thus to the axis of rotation A of the bearing. In the embodiment described, the diameter of the central bore of the sliding rings 8 is adapted to the outer diameter of the sliding sleeve 7 in such a manner that, when the bearing is assembled, the respective sliding rings 8 bear with their cylinder surface that defines the central bore on the outer circumferential surface 70 of the sliding sleeve 7, which can be seen on the sectional view of FIG. 3 that shall be explained below.

The respective sliding ring 8 has opposite flat sliding surfaces 80, 81 that are designated here as axial surfaces, wherein, the bearing being assembled, the axially outer axial surface 80 bears on an associated axial surface 60 of the circular disc 6 or of the axially inner axial surface 40 of the circular disc 4. Similarly, the respective axially inner axial surface 81 bears on an associated axial surface 20a or 20b of the first bearing ring 2 for the described decoupling of the two bearing elements in axial direction.

Fundamentally, the sliding elements can be made from a polymer material suitable for tribological purposes, in particular by an injection molding process. By contrast, the decoupling of the first bearing element and of the second bearing element is carried out by providing the sliding sleeve 7 that is arranged radially between the cylinder shoulder 5 and the first bearing ring 2. In an embodiment, at least one of the sliding rings can also comprise a sandwich structure in axial direction in the form of several superposed annular discs, wherein the axial extension of the sandwich structure is defined by the sum of the axial extensions of the superposed annular discs.

As explained, the axial and radial sliding bearing according to the invention of FIGS. 1 and 2 can be used for the relative rotation of two components, for example in the interior of a vehicle. This being, the second bearing element with the portions 4, 5, 6 includes fixing means for fixing to a first component and the second bearing element 2 fixing means for fixing to the second component of the vehicle. In the described embodiment, through bores 62 can be provided for this purpose on the second bearing element (4, 5, 6), wherein they extend through both circular discs 4, 6 as well as through the cylinder shoulder 5 and can be used, for example to fix the second bearing element (4, 5, 6) to a stationary or fixed portion or component, for example by means of a screw connection in which a respective screw bolt extends through an associated through bore and is screwed to the second component of the vehicle. Similarly, the first bearing ring 2 can include radially outwards to the sliding rings 8 a multitude of circumferentially spaced fastening bores 22 with which a further component, here the component movable to the second bearing element, is connected by screwing to the first bearing element or the first bearing ring.

FIG. 3 shows a sectional view of the axial and radial sliding bearing configured according to the invention of FIGS. 1 and 2 in assembled condition, wherein the section plane contains the axis A of the bearing and is indicated in FIG. 2 with the reference III-III. In particular the one piece configuration of the first component (4, 5) of the second bearing element (4, 5, 6) in the described embodiment can be recognized, wherein it is connected to the circular disc 6 by a screw connection coaxial to the axis of rotation of the bearing A for providing the second bearing element, wherein the second bearing element is configured with a U-shaped cross-section for completely axially accommodating and for partially radially accommodating the first bearing ring 2.

In the described embodiment, the sliding sleeve 7 extends axially over the overall axial accommodating of the second bearing element, i.e., the sum of the axial extensions of the both sliding rings 8 as well as of the first bearing ring 5 corresponds, i.e., is identical to the axial height of the sliding sleeve 7. In an embodiment that is not represented, it can also be provided that the inner diameter of the sliding rings 8 is adapted, i.e., is identical to the outer diameter of the cylinder shoulder 5 so that the sliding rings bear with their inner radial front face to the cylinder circumferential surface 50 of the cylinder shoulder 5 and the axial extension of the sliding sleeve 7 with reference to the axial extension of the accommodating of the second bearing element (4, 5, 6), that is defined by the axial spacing of the two circular discs 4, 5, is reduced by twice the axial extension of one of the sliding rings 8.

In an embodiment that is not represented, the axial and radial sliding bearing configured according to the invention can comprise a restricting means for restricting the relative movement of the two bearing elements 2 (4, 5, 6) to one another. To this end, an arm molded on a radial outer portion of a circular disc 4, 6 and extending axially can for example be provided, wherein it extends into a duct arranged in the first bearing ring 5 and extending circumferentially in the form of an elongated hole extending circumferentially, i.e., on a circular line portion, so that the relative movement of the two bearing elements 2 (4, 5, 6) to one another is restricted. This axial arm can be fixed to both circular discs for increasing the operational stability and extend axially between them.

### LIST OF REFERENCE NUMERALS

1 Axial and radial sliding bearing, bearing
2 First bearing ring, first bearing element
4 Bearing disc portion, circular disc
5 Cylinder shoulder, bearing cylinder portion
6 Bearing disc portion, circular disc
7 Sliding sleeve, axial sliding ring
8 Sliding ring, radial sliding ring
20a, b Axial surface of the first bearing ring
21 Radial surface, cylinder surface
22 Fastening bore
40 Axial surface of the circular disc
50 Radial surface, cylinder circumferential surface
51 Axial surface
52 Central bore
60 Axial surface
61 Threaded bore
62 Fastening bore
70 Radial surface, cylinder outer circumferential surface
71 Radial surface, cylinder inner circumferential surface
80 Axial surface
81 Axial surface
90 Fastening bolt
A Axis of rotation

1. An axial and radial sliding bearing (1) comprising
a first bearing element includes a first bearing ring (2);
a second bearing element (4, 5, 6), wherein the bearing elements are arranged rotatably to one another about a bearing axis (A), and the second bearing element (4, 5, 6) forms a substantially U-shaped cross-section in order to at least partially accommodate the first bearing ring (2); and,
sliding elements made of a polymer material that are arranged between the first and the second bearing element in order to axially and radially decouple the bearing elements,
wherein the second bearing element (4, 5, 6) comprises two bearing disc portions spaced from one another (4, 6) and at least one bearing cylinder portion (5) arranged between the two bearing disc portions and coaxially oriented to the first bearing ring (2), wherein the sliding elements (7, 8) have at least one axial sliding ring (7) to be arranged between radial surfaces associated with one another (50, 21) of the two bearing elements and two radial sliding rings (8) are arranged between axial surfaces associated with one another (60, 20a, 40, 20b) of the two bearing elements, wherein the axial sliding ring (7) is constructed in one piece and has a sleeve shape and that the radial sliding rings (8) are configured as respective ring discs so that the sliding functionality between the first and the second bearing element (2, 4, 5, 6) is provided by three sliding elements, each of them in one piece.

2. The axial and radial sliding bearing (1) according to claim 1, wherein an axial height of the bearing cylinder portion (5) is substantially equal to the sum of axial heights of the two radial sliding rings (8) and of an axial height of the first bearing ring (2) and moreover is substantially equal to an axial height of the axial sliding ring (7).

3. The axial and radial sliding bearing (1) according to claim 1, wherein the bearing cylinder portion (5) is configured in one piece with one of the two bearing disc portions (4, 6) to which the other of the two bearing disc portions (6, 4) is fixed.

4. The axial and radial sliding bearing (1) according to claim 1, wherein the bearing cylinder portion (5) is configured as a full cylinder and at least one of the two bearing disc portions (4, 6) is fixed to the bearing cylinder portion (5) with a screw connection.

5. The axial and radial sliding bearing (1) according to claim 1, wherein a multitude of axial ducts (62) arranged radially spaced from an axis of the bearing ring (2) are configured through the two bearing disc portions (4, 6) and the at least one bearing cylinder portion (5) arranged between the two bearing disc portions and oriented centered and coaxially thereto.

6. The axial and radial sliding bearing (1) according to claim 1, wherein a radial dimension of the bearing (1) is less than 80 mm and an axial dimension of the bearing is less than 20 mm.

7. The axial and radial sliding bearing (1) according to claim 1, wherein the bearing (1) comprises a restricting means for restricting a relative movement of the two bearing elements to one another.

8. The axial and radial sliding bearing (1) according to claim 7, wherein the restricting means comprises at least one first abutment arranged on the first bearing element (2) and at least one second abutment arranged on the second bearing element (4, 5, 6), wherein the two abutments associated to one another interact for restricting the relative rotation of the two bearing elements to one another.

9. The axial and radial sliding bearing (1) according to claim 7, wherein the restricting means comprises an arm portion arranged on one of the two bearing elements (2; 4, 5, 6) and extending axially therefrom that engages axially into an elongated hole extending circumferentially on the other of the two bearing elements for restricting the relative pivoting of the two bearing elements to one another to a predetermined angle range.

10. The axial and radial sliding bearing (1) according to claim 1, wherein at least one of the two bearing elements (2) has a seat for a latching element accommodated therein, and the other of the two bearing elements (4, 5, 6) comprises at least one latching recess associated to the latching element for accommodating at least partially the latching element for providing a releasable latch for a predetermined relative rotary position of the two bearing elements to one another.

11. A use of an axial and radial sliding bearing (1) according to claim 1 in the interior of vehicles.

12. The use of an axial and radial sliding bearing (1) according to claim 11, wherein the bearing is arranged for a pivotable fixing of a holding or a table element to a component of the interior of the vehicle, wherein the holding or table element is fixed to one of the bearing elements (2) and the component of the interior to the other of the two bearing elements (4, 5, 6).

13. The axial and radial sliding bearing (1) according to claim 1, wherein the bearing cylinder portion (5) is configured as a full cylinder and at least one of the two bearing disc portions (4, 6) is fixed to the bearing cylinder portion (5) with a screw connection extending coaxially to the first bearing element.

14. The axial and radial sliding bearing (1) according to claim 1, wherein a radial dimension of the bearing (1) is less than or equal to 60 mm and an axial dimension of the bearing is less than or equal to 16 mm.

15. The axial and radial sliding bearing (1) according to claim 1, wherein a radial dimension of the bearing (1) is less than or equal to 40 mm and an axial dimension of the bearing is less than or equal to 12 mm.

16. The axial and radial sliding bearing (1) according to claim 1, wherein at least one of the two bearing elements (2) has a seat for a spring-loaded deflectable latching element, and the other of the two bearing elements (4, 5, 6) comprises at least one latching recess associated to the spring-loaded deflectable latching element for accommodating at least partially the spring-loaded deflectable latching element for providing a releasable latch for a predetermined relative rotary position of the two bearing elements to one another.
